(19) United States
(12) Patent Application Publication
(10) Pub. No.: US 2012/0164551 A1
(43) Pub. Date: Jun. 28, 2012

(54) Decreasing Electrolyte Loss in PEM Fuel Cell

(75) Inventors: Christopher Faulkner, Hillsboro, OR (US); Yang Song, Portland, OR (US); Zakiul Kabir, Hillsboro, OR (US); Jason M. Tang, Hillsboro, OR (US)

(73) Assignee: CLEAREDGE POWER, INC., Hillsboro, OR (US)

(21) Appl. No.: 13/335,681

(22) Filed: Dec. 22, 2011

Related U.S. Application Data
(60) Provisional application No. 61/427,721, filed on Dec. 28, 2010.

(51) Int. Cl. H01M 8/04; B05D 5/12; B32B 37/04; H01M 8/24

(52) U.S. Cl. 429/457; 427/113; 156/308.2

(57) ABSTRACT

Embodiments are disclosed that relate to preventing electrolyte wicking by bipolar plates in a fuel cell system. In one example, a fuel cell system includes a first membrane-electrode assembly and a second membrane-electrode assembly. The fuel cell system further includes a bipolar plate disposed between the first membrane-electrode assembly and the second membrane-electrode assembly, the bipolar plate comprising a graphite layer and a surface energy adjustment layer.

### CROSS REFERENCE TO RELATED APPLICATIONS

The present application claims priority from U.S. Provisional Patent Application No. 61/427,721, filed Dec. 28, 2010 and entitled “Decreasing Electrolyte Loss in PEM Fuel Cell,” the entire contents of which is incorporated herein by reference.

### BACKGROUND

Fuel cells systems are useful for back-up and/or primary power applications. Fuel cells comprise, in part, a membrane-electrode assembly (MEA) comprising a membrane disposed between an anode and a cathode, and an electrolyte disposed within in the membrane. One example of an MEA is a high temperature proton exchange membrane (HT-PEM) assembly. HT-PEM assemblies may use phosphoric acid as the electrolyte and polybenzimidazole (PBI) or PBI polymer derivatives as the matrix/membrane to retain the electrolyte. In HT-PEM systems, some amount of acid may reside in the polymer matrix/membrane in the form of free acid.

Some fuel cell systems may comprise a stack of MEAs separated by bipolar plates, which function as current carriers between adjacent MEAs and also provide structural integrity to the fuel cell stack. End plates are used to cap either end of the fuel cell stack. Bipolar plates and end plates may be formed from any suitable material that provides the desired electrical conductivity, acid resistance, and structural integrity, including but not limited to graphite resins.

Loss of phosphoric acid from HT-PEM fuel cell membranes may result in low proton conductivity, high ohmic resistance, poor electrode kinetics, and performance degradation. Thus, it is desirable to manage phosphoric acid loss to achieve the desired operating efficiency of HT-PEM fuel cells. Phosphoric acid loss is conventionally believed to occur via evaporation from the membrane.

### BRIEF DESCRIPTION OF THE DRAWINGS

FIG. 1 is a schematic illustration of an embodiment of a back-up power supply system including a fuel cell system and various auxiliary components of the fuel cell system.

FIG. 2 is a schematic illustration of a first embodiment of a modified bipolar plate.

FIG. 3 is a schematic illustration of a second embodiment of a modified bipolar plate.

FIG. 4 is a schematic illustration of a third embodiment of a modified bipolar plate.

FIG. 5 is a schematic illustration of a fourth embodiment of a modified bipolar plate.

FIG. 6 is a graph comparing cell voltage over load time for a fuel cell with the modified bipolar plates of FIG. 2 compared to a fuel cell without modified bipolar places.

FIG. 7 is a bar graph showing remaining acid content in membranes of a fuel cell with the modified bipolar plates of FIG. 2 compared to a fuel cell without modified bipolar plates.

FIG. 8 is a graph comparing cell voltage over load time for a fuel cell with the modified bipolar plates of FIG. 3 compared to a fuel cell without modified bipolar places.

FIG. 9 is a bar graph showing remaining acid content in membranes of a fuel cell with the modified bipolar plates of FIG. 3 compared to a fuel cell without modified bipolar plates.

FIG. 10 is a graph comparing cell voltage over load time for a fuel cell with the modified bipolar plates of FIG. 4 compared to a fuel cell without modified bipolar places.

### DETAILED DESCRIPTION OF THE DEPICTED EMBODIMENTS

The inventors herein have recognized that, contrary to the conventional belief that acid/electrolyte loss is primarily caused by evaporation, a minimal amount of acid may be lost due to vaporization at the operating temperatures (e.g., <200° C.) of an HT-PEM fuel cell, and a majority of acid/electrolyte loss may occur via graphite bipolar plate and/or end plate electrolyte uptake/wicking driven by plate porosity. Further, the inventors have recognized that decreasing acid wicking of the graphite bipolar plate may increase the lifetime and efficiency of an HT-PEM fuel cell. The embodiments described herein may mitigate acid loss, corrosion of bipolar plates, and degradation of fuel cell performance arising from acid wicking by controlling the surface energy of graphite bipolar plate material, making the plate resistant to corrosion and porosity formation. While described herein in the context of bipolar plates, it will be understood that the disclosed embodiments also may apply to end plates.

Wicking occurs due to the capillary forces present within graphite-resin bipolar material due to porosity. Graphite in its natural state is primarily hydrophobic, with a Rame-Hart static contact angle measuring>100°. However, the graphite is subject to chemical attack by the acidic electrolyte. This may increase the surface energy of the graphite such that, if not abated, water may completely wet the surface (contact angle<15°). The porosity of graphite exaggerates the effect of its surface energy on wetting properties. Thus, if the surface energy increases, the porous graphite surface becomes increasingly wettable.

As the surface energy of the bipolar plate increases in-situ, more phosphoric acid may be attracted to the plate. However, if the surface energy of the bipolar plate remains sufficiently low, the pathways available for acid wicking may be significantly reduced. Thus, modifying the surface of the bipolar plate to have of sufficiently low surface energy throughout the life of the fuel cell, via physical or chemical treatments or any combination of the two, may help to mitigate acid loss, bipolar plate corrosion, and fuel cell performance degradation.

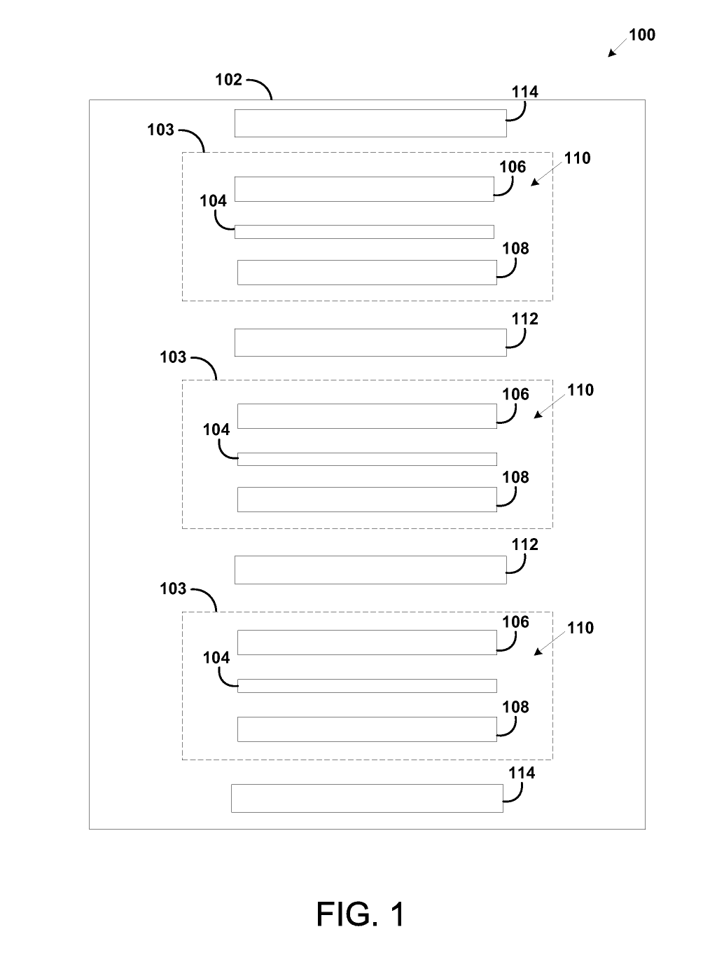

Referring now to FIG. 1, a schematic illustration of a fuel cell system is shown at 100. Fuel cell system 100 includes a fuel cell assembly 102 including a plurality of fuel cells 103 that are connected in series to generate a desired voltage. Each fuel cell 103 includes a proton exchange membrane 104 disposed between a cathode electrode 106 and an anode electrode 108. The cathode, anode and proton exchange membrane comprise a membrane-electrode assembly (MEA) 110. A bipolar plate 112 is disposed between the anode and cathode of two adjacent fuel cells in a fuel cell stack. The bipolar plate may include integrated flow fields to distribute fuel and oxidant, or separate flow field structures (not shown) may be disposed between the bipolar plate and the electrodes on either side of the bipolar plate. In operation of the fuel cell, bipolar plate 112 conducts electrical current between the anode of one MEA and the cathode of an adjacent MEA. End plates 114 terminate the fuel cell assembly 102.

The proton exchange membrane 104 includes a proton-conducting material, such as phosphoric acid in a PBI matrix, configured to transport protons generated at the anode. In other embodiments, the PBI membrane may be doped with sulfuric acid or other suitable acid(s).

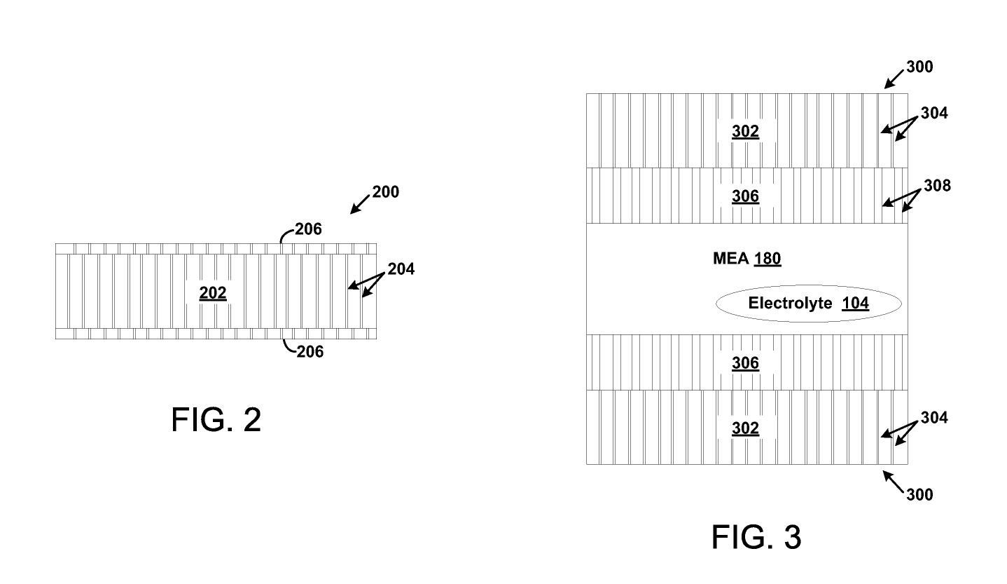

As described above, the proton exchange membrane may undergo electrolyte/phosphoric acid loss. As the majority of electrolyte/phosphoric acid loss may occur via wicking due to the porosity of bipolar plates, FIGS. 2-5 illustrate embodiments of modified bipolar plates configured to limit such wicking. This may help to reduce electrolyte loss compared to ordinary bipolar plates, and thereby may increase fuel cell life and efficiency. It will be appreciated that the examples provided in FIGS. 2-5 are not intended to be limiting, but merely illustrative of structures for reducing electrolyte wicking into a bipolar plate. It further will be understood that the depicted embodiments may be used alone or in combination.

FIG. 2 shows a schematic depiction of a first example embodiment of a modified bipolar plate 200. Modified bipolar plate 200 includes an inner graphite resin layer 202 comprising a matrix with pores 204. Further, an outer sealing layer 206 is disposed over inner graphite resin layer 202, thereby sealing pores 204 and helping to reduce wicking of electrolyte into pores 204. Outer sealing layer 206 may be made from any suitable material, including but not limited to diamond, diamond-like-carbon (DLC), or a same or similar material as inner graphite layer 202.

Outer sealing layer 206 may be bonded to inner graphite resin layer 202 either physically or chemically. In some embodiments where the sealant comprises a carbon-based material (e.g., a graphite resin), the outer sealing layer 206 may initially be physically applied, and subsequent heat treatment, for example in an oven or furnace at temperatures greater than 900° C. (e.g. as described in Christner and Farooque, 1984, NASA Document ID: 19840066957) in an inert environment may be used to convert the sealant to more chemically inert forms of carbon. This may help to lower the surface energy of the bipolar plate compared to an unsealed bipolar plate.

FIG. 3 depicts a schematic depiction of a second example embodiment of a modified bipolar plate 300. Modified bipolar plate 300 includes graphite-resin material in a graphite layer 302 comprising a matrix with exposed pores 304, as described above. Further, an additional porous media layer 306 is disposed between the graphite layer 302 and the MEA 180 and electrolyte 104. The additional porous media layer 306 comprises a matrix with exposed pores 308 having a larger width diameter than exposed pores 304. Pores 308 may have any suitable width. Examples include, but are not limited to, widths in a range of 10-300 microns.

Additional porous media layer 306 may be formed from any suitable material. Suitable materials include materials having a desired pore width, that are sufficiently electrically conductive, and/or that are sufficiently resistant to corrosion from the chemical environment of the fuel cell. Example materials include, but are not limited to, carbon fiber-based papers. Additional porous media layer 306 may disrupt the acid wicking pathway by decreasing the potential for capillary action. Further, the surface energy of the bipolar plate 302 may be decreased relative to that of layer 306.

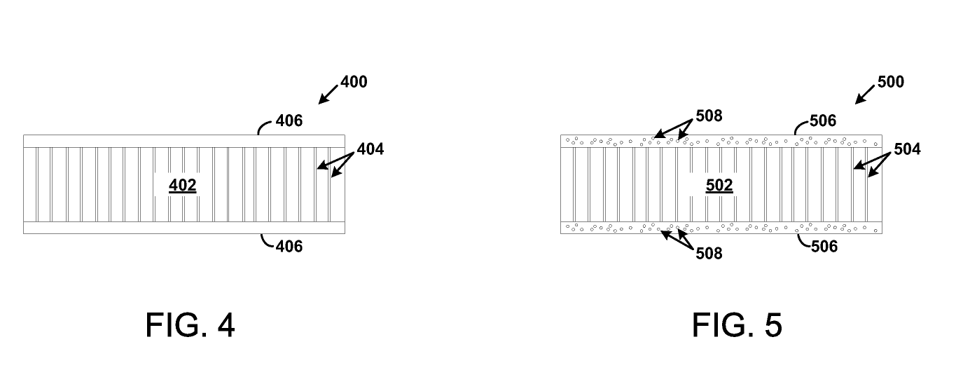

FIG. 4 shows a schematic depiction of a third example embodiment of a modified bipolar plate 400. Modified bipolar plate 400 includes graphite-resin material in a graphite layer 402 comprising a matrix with exposed pores 404, as described above. Further, a chemically robust, low surface energy material is included in an outer polymer or inorganic layer 406. The material is selected to be resistant to oxidation and temperature degradation, and to have an inherently low surface energy. Examples of suitable materials for forming outer layer 406 include, but are not limited to, polytetrafluoroethylene (PTFE) and derivatives, polyvinylfluoride, fluorinated methacrylates, other fluorinated polymers, polyether ether ketone (PEEK) and other non-fluorinated polymers and inorganic matrices, such as silicon carbide.

Polymer layer 406 may be chemically and/or physically applied to the graphite layer 402. Examples of physical application methods include, but are not limited to, spray-coating, dip-coating, spin-coating, brushing, and screen printing methods. Examples of chemical application methods include, but are not limited to, grafting-to and grafting-from methods. Grafting-to techniques include, but are not limited to, polymerizations such as living radical polymerization, atom transfer radical polymerization (ATRP), metathesis polymerization, ring-opening metathesis polymerization (ROMP), and reversible addition-fragmentation chain transfer polymerization (RAFT). Grafting-from techniques utilize surface-initiated forms of the aforementioned polymerization techniques. It will be understood that a chemically bonded polymer film may have a stronger bond to the graphite resin material than a physically-applied polymer layer.

FIG. 5 shows a fourth example embodiment of a modified bipolar plate 500. Modified bipolar plate 500 includes graphite-resin material in a graphite layer 502 comprising a matrix with exposed pores 504, and an outer layer 506. The outer layer 506 comprises a chemically robust, low surface energy material configured to be resistant to oxidation and temperature degradation, and to have an inherently low surface energy, such as the polymers and inorganic materials described above in reference to the third example embodiment. Additionally, the outer layer 506 includes electrically conductive particles 508, such as carbon black, synthetic or natural graphite, carbon fibers, or gold particles, to increase the conductivity of the polymer or inorganic layer. It will be understood that these specific materials are described for the purpose of example, and are not intended to be limiting in any manner. The outer layer 506 may be added to the graphite layer 502 in any suitable manner, including the techniques discussed above in reference to the third embodiment. The electrically conductive particles 508 may help to improve an electrical conductivity of the outer layer 506, and thereby help to reduce an internal resistance of the fuel cell stack.

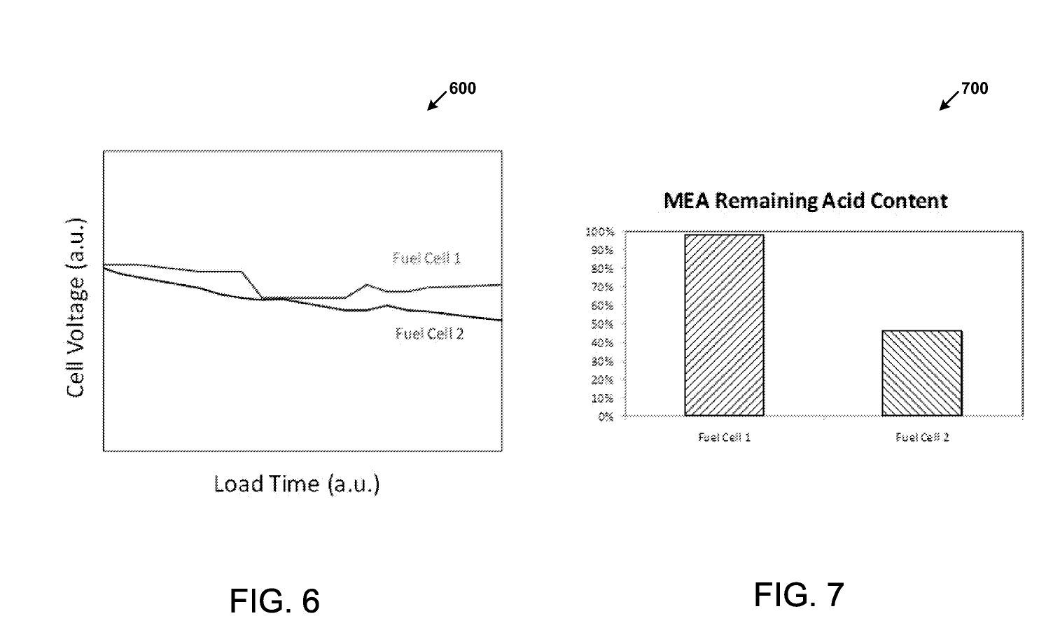

FIG. 6 shows a graph 600 depicting cell voltage as a function of time (in arbitrary units) for a fuel cell having unmodified bipolar plates compared to a fuel cell having bipolar plates modified as described above for FIG. 2. In FIG. 6, a first line (Fuel Cell 1) shows the activity of a first fuel cell including modified bipolar plates, while a second line (Fuel Cell 2) shows the activity of a second fuel cell including unmodified bipolar plates. The second fuel cell shows a greater decay rate than the first fuel cell.

FIG. 7 shows a bar graph 700 depicting a remaining acid content in the fuel cells of FIG. 6 after a period of operation. From these results, it can be seen that the membranes of the first fuel cell have a greater remaining acid content than those of the second fuel cell. In this specific example, the remaining acid content of membranes from the first fuel cell is greater than 95%, while the remaining acid content of membranes from the second fuel cell is less than 50%. Thus, in this example, the fuel cell including modified bipolar plates shows decreased performance degradation and acid loss over time compared to the fuel cell with unmodified bipolar plates.

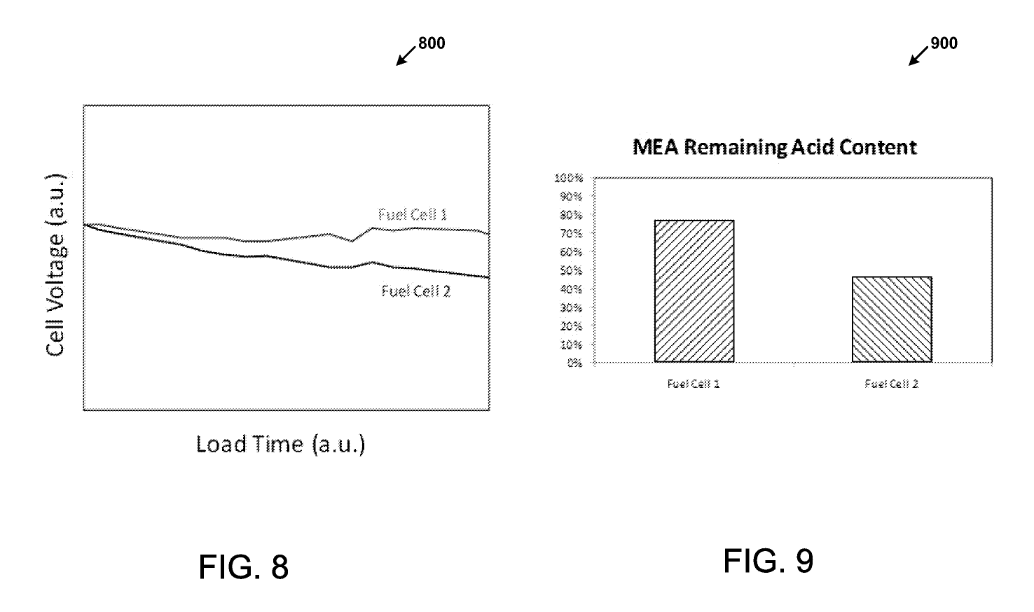

FIG. 8 shows a graph 800 depicting cell voltage as a function of time (in arbitrary units) for a fuel cell system having unmodified bipolar plates compared to a fuel cell system having bipolar plates modified by application of a material having a larger average pore size than the bipolar plate, as described above with reference to FIG. 3. A first line (Fuel Cell 1) shows the activity of a first fuel cell including modified bipolar plates, while a second line (Fuel Cell 2) shows the activity of a second fuel cell including unmodified bipolar plates. As can be seen in these results, the second fuel cell shows a greater decay rate than the first fuel cell.

FIG. 9 shows a bar graph 900 depicting a remaining acid content in the fuel cell systems shown in FIG. 8 after a period of operation. As can be seen, the membranes of the first system with the modified bipolar plates have a greater acid content than those of the second fuel cell system with the unmodified bipolar plates. In this specific example, the remaining acid content of membranes from the first fuel cell is greater than 75%, while the remaining acid content of membranes from the second fuel cell is less than 50%. Thus, in this example, the fuel cell system with modified bipolar plates shows reduced acid loss and performance decay over time.

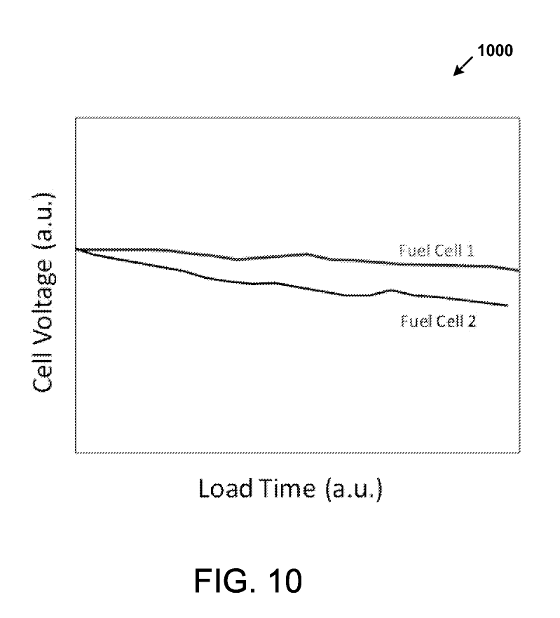

FIG. 10 shows a graph 1000 depicting cell voltage as a function of time (in arbitrary units) for a fuel cell system having unmodified bipolar plates compared to a fuel cell system having bipolar plates modified via sealing with PTFE, as described above with reference to FIG. 4. A first line (Fuel Cell 1) shows the activity of the fuel cell system with the modified bipolar plates, while a second line (Fuel Cell 2) shows the activity of the fuel cell system with the unmodified bipolar plates. It is again seen that the fuel cell system with the unmodified bipolar plates shows a greater decay rate than the fuel cell system with the modified bipolar plates.

Thus, the use of bipolar plates and/or end plates that are modified to reduce acid wicking may help to mitigate acid loss, bipolar plate corrosion, and fuel cell performance degradation, and therefore increase fuel cell lifetime. Although the present disclosure includes specific embodiments, specific embodiments are not to be considered in a limiting sense, because numerous variations are possible. The subject matter of the present disclosure includes all novel and non-obvious combinations and subcombinations of the various elements, features, functions, and/or properties disclosed herein.

1. A fuel cell system, comprising:
a first membrane-electrode assembly and a second membrane-electrode assembly; and
a bipolar plate disposed between the first membrane-electrode assembly and the second membrane-electrode assembly, the bipolar plate comprising a graphite layer and a surface energy adjustment layer disposed between the graphite layer and one or more of the first membrane-electrode assembly and the second membrane-electrode assembly, the surface energy adjustment layer being configured to disrupt electrolyte wicking into pores of the graphite layer.

2. The fuel cell system of claim 1, wherein the surface energy adjustment layer comprises a sealing layer.

3. The fuel cell system of claim 2, wherein the sealing layer comprises one or more of diamond and diamond-like carbon.

4. The fuel cell system of claim 1, wherein the surface energy adjustment layer comprises a porous media layer with pores of a larger width diameter than pores of the graphite layer.

5. The fuel cell system of claim 4, wherein the pores of the porous media layer comprise an average width of between 10 and 300 microns.

6. The fuel cell system of claim 1, wherein the surface energy adjustment layer comprises one or more of a polymer and a doped polymer.

7. The fuel cell system of claim 6, wherein the doped polymer is doped with electrically conductive particles.

8. The fuel cell system of claim 6, wherein the polymer comprises one or more of polytetrafluroethylene, polyvinylfluoride, fluorinated methacrylate, and polyether ether keytone.

9. The fuel cell system of claim 1, wherein the surface energy adjustment layer is chemically or physically bonded to the graphite layer.

10. A bipolar plate for a fuel cell system, comprising:
a porous graphite layer; and
a surface energy adjustment layer disposed on at least one side of the graphite layer and configured to disrupt electrolyte wicking into pores of the graphite layer.

11. The bipolar plate of claim 10, wherein the surface energy adjustment layer comprise one or more of one of diamond and diamond-like carbon.

12. The bipolar plate of claim 10, wherein the surface energy adjustment layer comprises pores of a larger average diameter than the pores of the graphite layer.

13. The bipolar plate of claim 10, wherein the bipolar plate is disposed between a cathode electrode of a first membrane-electrode assembly of the fuel cell system and an anode electrode of a second membrane-electrode assembly of the fuel cell system.

14. The bipolar plate of claim 13, wherein the surface energy adjustment layer is disposed between one side of the graphite layer and the first membrane-electrode assembly and between another side of the graphite layer and the second membrane-electrode assembly.

15. The bipolar plate of claim 10, wherein the surface energy adjustment layer comprises one or more of an inorganic material, a polymer, and a doped polymer.

16. A method of making a bipolar plate for a fuel cell system, the method comprising:
applying a surface energy adjustment layer to each side of a graphite layer of the bipolar plate such that the surface energy adjustment layer is configured to be disposed between the graphite layer and a membrane-electrode assembly in the fuel cell system.

17. The method of claim 16, wherein the surface energy adjustment layer comprises a carbon-based material, and further comprising physically bonding the carbon-based material to the graphite layer and subsequently exposing the carbon-based material to a heat treatment.

18. The method of claim 16, wherein the surface energy adjustment layer comprises a porous media layer with pores of a larger width diameter than pores of the graphite layer.

19. The method of claim 16, wherein the surface energy adjustment layer comprises a polymer, and further comprising applying the polymer via one or more of spray-coating, dip-coating, brushing, and screen printing.

20. The method of claim 19, further comprising doping the polymer with an electrically conductive material.
